(19) United States
(12) Patent Application Publication
(10) Pub. No.: US 2012/0297960 A1
(43) Pub. Date: Nov. 29, 2012

(54) SOUND SHOE STUDIO

(76) Inventor: Rohan Bader, Markham (CA)

(21) Appl. No.: 13/118,437

(22) Filed: May 29, 2011

(51) Int. Cl. G10H 1/32

(52) U.S. Cl. 84/644

(57) ABSTRACT

A sound shoe having multiplicity of musical instruments, said instruments being one or more of a tambourine, jingles, Djembe shakers, a spoke to play a guiro, cymbals or cowbells, a bell, claps, wooden clackers generate. The shoe being able to mix sound generated by the shoe with other musical sounds and record them at the same time. This shoe allows for adjusting, amplifying and controlling of the music and audio generated within the shoe. The shoe performing equalization, reverberation and editing of the waveforms and MIDI sounds.

### FIELD OF THE INVENTION

The present invention relates to foot operated musical devices in communication with a microprocessor to receive sound inputs from various sources and combine them to form a new sound output. The shoe, therefore, acts as a sound studio and musical instrument.

### BACKGROUND OF THE INVENTION

This invention relates generally to a sound or music shoe, and more particularly, to a shoe that has capability of generating sound and mixing it with other sounds, as well as capability to record and playback the new sounds all inside the shoe, so functioning as a music studio. U.S. Pat. No. 7,786,365 issued to Rohan Bader, discloses a foot operated musical instruments integrated with a shoe, which allows musicians to play multiple instruments at the same time. The present invention is a foot operated musical instrument which further allows musicians to record, mix, modify and play different sounds from different sources.

The prior art discloses various forms of foot operated musical instruments. Most of the prior foot operated musical instruments comprise of a separated musical instrument, such as a tambourine, which is mounted onto a shoe. Many of them require extra strings for attachment to the user's feet. They are difficult to play and more difficult to control. In addition, they do not have any means to combine their sound with other musical sounds.

Prior art also discloses shoes which can play music. For example U.S. Pat. No. 4,571,680 discloses an electronic music pace counting shoe which plays music while the user of the shoe is walking or otherwise using the shoe. Such shoes can only play the music which is included in the electronic device.

Prior art also discloses shoes which have record and playback functions installed inside them. For example, U.S. Pat. No. 5,615,111 issued to Raskas & Schuver discloses a shoe that can receive, record and store signals in a memory, and then playback or transmit the recorded signals from the memory.

While the prior art achieve their objectives, they do not disclose any of the elements of the present invention, and do not provide a musical shoe with tambourine, jingles, bells, clackers, clapper, shakers or removable tap shoe soles in combination with a microprocessor based digital recording unit to received and mix other sounds, in conjunction with an a Music Player of multiple formats (MP3, Wave, Aiff, etc), a Video Camera, a wireless modem, a screen, an HDMI output, a and USB. The shoe can generate live music and record music simultaneously.

### SUMMARY OF THE INVENTION

The present invention is a shoe that can be used as a musical instrument generating several different sounds. This shoe is also able to mix these sounds with other musical sounds and record them all at the same time. This shoe allows for adjusting, amplifying and controlling of the music and audio generated within, as well as with other musical sounds all by the same shoe. The shoe also performs other tasks such as equalization, reverberation and editing of the waveforms and MIDI sounds. Alternatively, the signal can be enhanced or improved by digital processing techniques to eliminate imperfections in the original sound. When the shoe is on and certain musical sounds are being generated, the sound shoe studio acts as a sound mixer, processing the sound and generating an output.

The sound shoe studio is an easy to use instrument and multi-track music recorder built into one unit for musicians to either make music with, or to record music on. It functions as an instrument, and a recording station.

One embodiment of the present shoe comprises of one or more musical instruments, means for receiving, recording, transmitting and playback of sounds, and means for controlling the volume of all sounds received and played back.

In light of the foregoing comments, it will be recognized that a principal object of the present invention is to provide a record and playback means for shoes.

These and other objects and advantages of the present invention will become apparent after considering the following detailed specification in conjunction with the accompanying drawings, wherein:

### BRIEF DESCRIPTION OF THE DRAWINGS

In the figures, which illustrate, by way of example only, embodiments of the present invention,

FIG. 1 illustrates a musical shoe according to an embodiment of the present invention;

FIG. 2 is exploded view of the display system on the shoe; and

FIG. 3 illustrates a flow chart for various functions of the musical shoe.

### DETAILED DESCRIPTION OF THE INVENTION

The sound shoe studio is an easy to use music instrument and multi-track music recorder built into one unit for musicians to either make music with, or to record music on. It functions as an instrument, and a recording station.

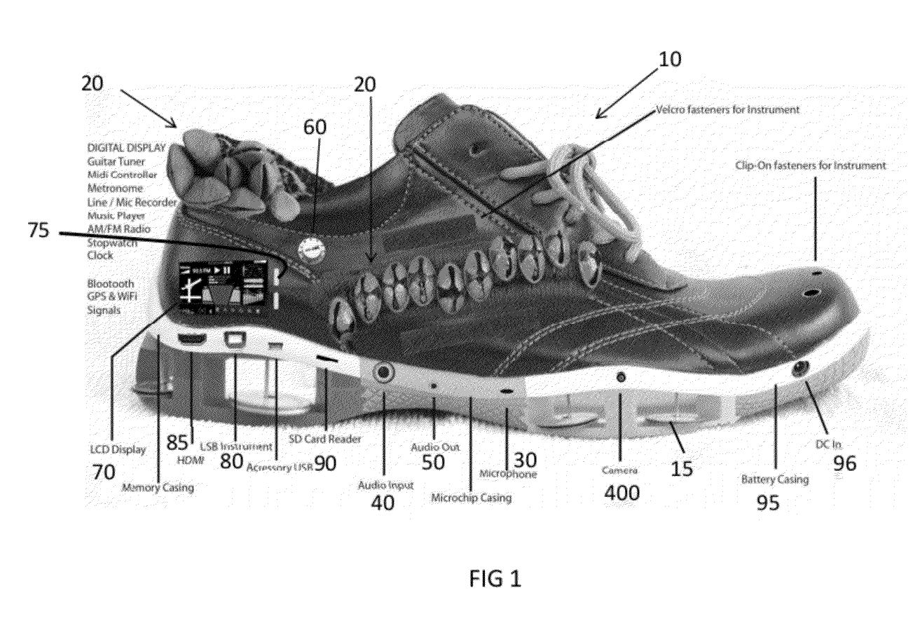

The Sound Shoe Studio is a shoe with various percussion instruments that the user can easily play by tapping their foot, or walk with while wearing. FIG. 1 illustrates one embodiment of the sound shoe studio 10. FIG. 1 represents a shoe with small jingles 15 attached to its bottom. FIG. 1 illustrates by way of example two locations in which the shakers 20 are attached to the shoe as well. However, shakers, jingles, and bells can be attached to any location on the shoe.

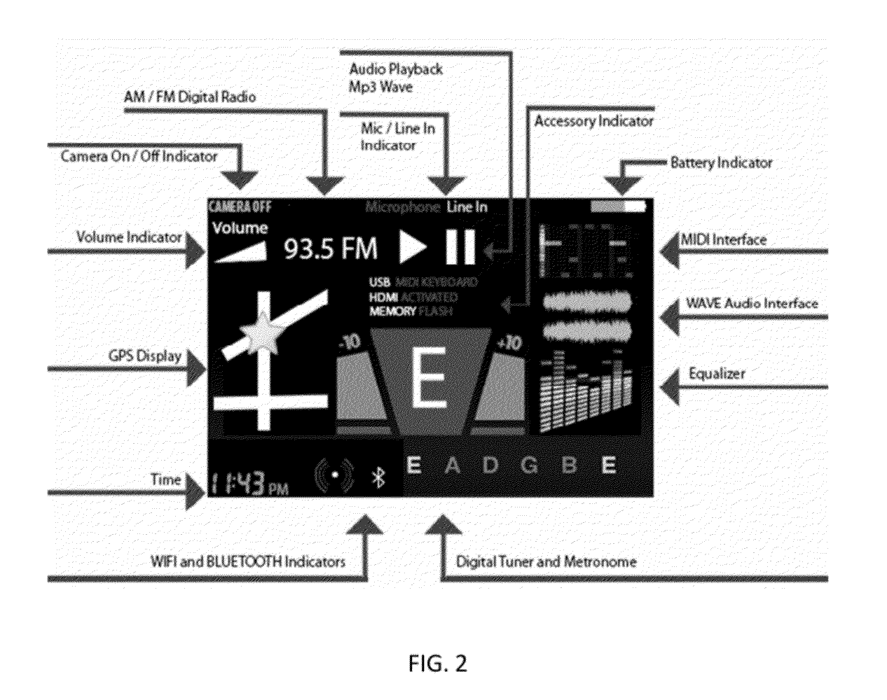

The sound shoe further comprises audio input systems and can receive sound by various means. A microphone 30 is installed inside the sole of the shoe to receive sounds generated by the shoe as well as other external sounds. In addition, an input jack 40 is installed inside the shoe to let the shoe receive sound from other devices. The shoe can also transmit sound in various ways. It has an audio output jack 50 to connect the shoe to a speaker or other musical devices. A built in volume and on-off switch 60 controls the sound level out of the shoe. The shoe also has a multi-function touch screen display 70 (with optional buttons 75) to control various digital functions that the shoe can perform, including sounds that are received by the shoe. Volume control 60 is located on the shoe and can be easily accessed by the user to change the playback volume. The two buttons 75 next to the Display (or Touch Screen or other types) 70 allow the user to change the various screen display menus and adjust the brightness level of the screen. FIG. 2 shows the exploded view of the display and its functionalities. Other devices, such as USB ports 80, HDMI audio/video output 85 are also installed on the shoe. The user can either wear the shoe or place it on a table or floor to record audio. The shoe includes an internal memory card, as well as an SD card reader 90. The shoe has an internal battery compartment, as well as a DC Power input 96. The memory and battery system is sized to fit inside the shoe. The shoe also has a mini-camera for recording shows or practice sessions, helpful to the musician.

The sound shoe studio has a Digital Metronome so that the user can keep beat, a Digital Tuner so the user can tune their instruments, a Digital Midi controller (USB connected) so the user can attach a Midi Keyboard or other compatible instruments, a Digital clock/stopwatch and a Digital AM/FM Radio/music player. The shoe also has a Digital GPS system so the user can let fans know where they are playing with the click of a button, and a WIFI system so they can connect to the internet. FIG. 2 illustrates various functions of the shoe which can be controlled using the display unit.

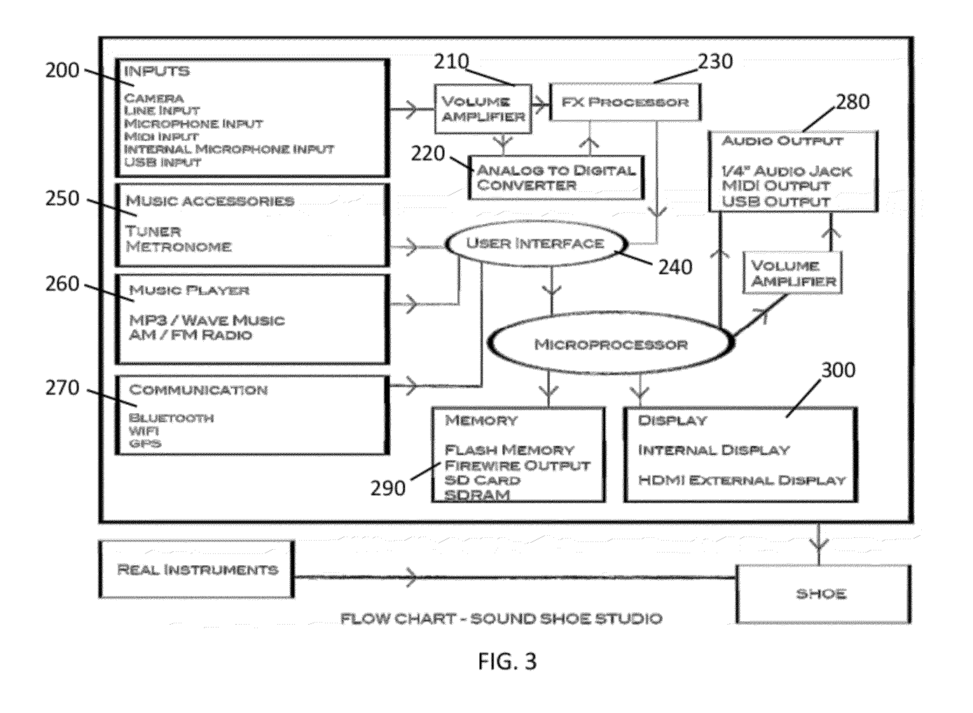

FIG. 3 illustrates various functions of the sound shoe studio 200. The audio input from various devices is taken to a volume amplifier 210, an analog to digital converter 220, a FX processor 230, and then to a user interface system 240. FX processor is used to add effects and enhance the sound, such as echo, reverberation, equalization, or other distortions. The user interface operates in cooperation with a microprocessor for more functionality. In one embodiment, a 2 GHz Core Duo INTEL multi-processor is used. However, any 2 GHz or greater multi-processor that has multitasking capability can be used. In another embodiment, the shoe may act as a computer, designed as a wearable shoe with a focus on Audio Recording.

A user interface system 240 allows a user to choose audio input, music accessories 250 (such as tuner and metronome), music player 260 (MP3 (.mp3) /Wave (.wav) /Aiff (.aif) format music or AM/FM radio) or other communication systems 270 (such as Bluetooth, WIFI, GPS, etc.). The user chooses the function to go to the microprocessor. The microprocessor controls audio output 280, the memory 290, and the display system 300. The sound generated by the music shoe can be mixed with other sounds. The other sounds can be generated from a plurality of devices including but not limited to, a digital multi-format audio player (.Mp3, .Wav or .Aiff), Line In Processor, Built In Microphone Processor, Analog and Digital Audio Output, and other audio sources. Wireless sounds may be achieved using Bluetooth technology. The shoe has embedded in it Bluetooth technology to connect to other devices such as wireless headphones, microphones, guitars, and keyboards with wireless capability, creating a wireless recording experience.

The output can be saved on internal memory while visuals (audio waves, midi interface, etc) are displayed on the Display 70 on the shoe. The shoe has various memory outputs, including Internal FLASH Memory, FIREWIRE, SD Card Slot and SDRAM. The FIREWIRE output is a high-speed wire that connects to an external hard drive for backup purposes. The Internal FLASH memory operates like a Hard Drive, except has no moving parts. The SD Card Slot provides the user with data on a portable reusable chip. This chip can also contain MIDI samples that the user can manipulate with a keyboard when activated (MIDI samples are readily available from music stores and online).

After the music passes through the Microprocessor, it is saved in WAVE (.wav) format on SDRAM and then sends the information to Internal Flash Memory, (or SD CARD and External Hard Drive) The SDRAM stores recently recorded WAVE form music, this creates an instant high quality playback of music, as well as a buffer for information before it is stored on the Internal Flash Memory.

The On-Shoe Display and HDMI are mirror images of each other. The HDMI output simply gives the user a larger viewing format if they choose to plug in a HDMI compatible monitor.

After the information goes through the microprocessor, a visual representation of the WAVE form music shows the user what they are recording, on the HDMI and On-Shoe Display. The wave music may appear on multiple track levels, as illustrated in FIG. 2.

In another embodiment, the shoe is able to store and load software that can be loaded onto the shoe. This would also helps with various internet functions. Also this would allow the shoe to be updated with the latest software. Most sounds are patched into the shoe via the inputs. All sounds, with or without wires, will pass through the VOLUME—then DIGITAL CONVERTER (translates into .Wav digital file)—then EFFECTS—then they go to the processor—then saved on Memory.

The process of making music in a live performance comprises of the following steps: There are two ways that sound is created by a person wearing the music shoe. The real instruments attached make sounds as the user moves their foot while wearing shoe. The other way sounds are created involves turning the shoe on and attaching electric and digital instruments to the shoe (electric guitar, MIDI keyboard, USB compatible instruments, etc), with all, amplified new sounds being heard through an Audio Output.

In another embodiment of the same shoe, a camera 400 having video capability is also embedded in the shoe. The camera has a High Definition pixel ratio, while micro sized taking only a very limited space. This allows musicians or bands to record their practice or live performance. The camera can be installed on any location on the shoe, preferably on the toe of the shoe.

While the invention has been described in terms of various specific embodiments, those skilled in the art will recognize that the invention can be practiced with modification within the spirit and scope of the claims.

Since many modifications, variations and changes in detail may be made to the presently described embodiment, it is intended that all matters in the foregoing description and accompanying drawings be interpreted as illustrative and not by way of limitation.

What is claimed is:

1. A sound shoe studio, comprising a shoe having:
a. sound generating instruments;
b. an audio input system to receive signals;
c. at least one sound recording system;
d. at least one sound playback system;
e. memory means;
f. an audio output system and sound transmitting means; and
g. a sound processing system to receive sound signals from said audio input system, amplify, mix and add other sound effects to received sound signals, and to generate a new sound signal, transmit said new sound signal to a memory device for new sound to be played back through said audio output system.

2. The sound shoe studio of claim 1, wherein said sound generating instruments being incorporated within the shoe and being an integral part of the shoe.

3. The sound shoe studio of claim 1, wherein said sound generating instruments having attaching means to removably attach to the shoe.

4. The sound shoe studio of claim 3, wherein said attaching means comprising any of straps, magnets, elastic bands, Velcro straps, nylon strap with a plastic tightening device, clips, shoe receiving pockets, and plastic and metal buttons.

5. The sound shoe studio of claim 1, wherein said sound generating instruments being one or more of a tambourine, jingles, Djembe shakers, a spoke to play a guiro, cymbals or cowbells, a bell, claps, wooden clackers.

6. The sound shoe studio of claim 1, wherein said audio input and audio output systems comprising at least one internal microphone, a ¼″ line-in jack, a MIDI device connection, and a USB.

7. The sound shoe studio of claim 1, wherein said audio output system comprising a headphone output and a HDMI output.

8. The sound shoe studio of claim 1, further comprising a wireless internet modem.

9. The sound shoe studio of claim 1, further comprising music accessories comprising at least a music tuner and a metronome.

10. The sound shoe studio of claim 1, further comprising a clock.

11. The sound shoe studio of claim 1, further comprising at least one of MP3, Wave, and Aiff audio player, and AM/FM radio.

12. The sound shoe studio of claim 1, further comprising of at least one Bluetooth, WIFI and GPS.

13. The sound shoe studio of claim 1, further comprising a micro-video camera.

14. The sound shoe studio of claim 1, further comprising a wireless transmitter means to wirelessly transmit sound from the shoe to a remote receiver.

15. The sound shoe studio of claim 1, further comprising of a display screen, preferably a touch-screen.
